(19) United States
(12) Patent Application Publication
(10) Pub. No.: US 2016/0178485 A1
(43) Pub. Date: Jun. 23, 2016

(54) Feedback System and Method for Timely Assessment of a Condition of Bulk Materials

(71) Applicant: Hollison, LLC, Owensboro, KY (US)

(72) Inventors: KEVIN E. HUMPHREY, Owensboro, KY (US); ANTHONY D. BASHALL, Owensboro, KY (US)

(21) Appl. No.: 14/971,051

(22) Filed: Dec. 16, 2015

Related U.S. Application Data
(60) Provisional application No. 62/094,664, filed on Dec. 19, 2014.

(51) Int. Cl. G01N 1/04

(52) U.S. Cl. CPC G01N 1/04

(57) ABSTRACT

Bulk materials from a transport vehicle are transitioned along a transitioning line to a sampling point, at which location particles of matter in the air surrounding the bulk materials are sampled. When the present embodiments are combined with near-real time detection methods, it establishes a near-real time feedback loop to make acceptance/rejection decisions more quickly than with prior sampling and testing approaches. Thus, the embodiments avoid or limit the waiting time that are seen with current systems and methods for assessing quality and condition of bulk materials at a point of delivery.

### PRIORITY STATEMENT

This patent application claims the benefit of priority to U.S. Provisional Patent Application Ser. No. 62/094,664, with a filing date of Dec. 19, 2014.

### FIELD OF INVENTION

Embodiments described herein relate to determining the integrity of a shipment of bulk materials which are obtained from, transported to, used in the manufacture of goods at, stored at, or otherwise handled at a site, and the embodiments provide feedback to make acceptance/rejection decisions more quickly than with prior sampling and testing systems.

### BACKGROUND

In commerce, many goods are sold as bulk materials. The term “bulk materials” refers to items obtained, transported, used, stored, or handled in a group, non-limiting examples of which include grain, wheat, vegetables, tea, spices, flavorings, peanuts, coffee beans, soybeans, and other agricultural products; manufactured food products (including pet food products); pharmaceutical products; health products like multivitamins and supplements. Packages which are handled and shipped are also an example of bulk materials according to the descriptions and teachings herein. Each example is an item that is comprised of, or can be broken down into, individual units and grouped with numerous others of its kind for shipment, and each example is the kind of article that can cause significant harm if it is a contaminated or otherwise carries some harmful substance.

Such substances include, but are not limited to, matter that causes injury, disease, or irritation if inhaled or ingested into the system or absorbed through the skin; and matter that may create a risk of combustion or explosion, either by itself or in contact with other matter; or that may react with other matter to produce unwanted chemical reactions; or an additive used to enhance a manufacturing process; or matter providing beneficial, nutritional, or therapeutic effects. Such matter is characterized in different ways, and depending on its nature may be referred to variously as contaminants, adulterants, pathogens, viruses, bacteria, microorganisms, fungi, toxins, toxic chemicals, and pollutants. For brevity, such examples which are associated with injury are referred to herein as “contaminants.”

Alternatively, a need exists to sample bulk materials to determine if some substance is present that is desirable, i.e., which is supposed to be present. Such substances include, again by way of illustration only, an additive used to enhance a manufacturing process related to a particular commodity; or matter incorporated with a particular commodity providing beneficial, nutritional, or therapeutic effects, such as proteins, nanoparticles, and additives. For brevity, all such substances contemplated by this paragraph are referred to, individually and collectively, as “additives.” Accordingly, in the disclosure provided herein, the same teachings apply to “contaminants” and “additives.”

When bulk materials are obtained, transported, used, stored, or handled, often the activity is associated with the transition of the bulk materials from one space to another space. In this sense, “transition” and “transitioning” as used herein refer to moving location. When bulk materials are obtained, transported, used, stored, or handled, it is often necessary and appropriate to know whether they are contaminated. If bulk materials found at a site are contaminated, it threatens to compromise the integrity of the manufactured product, or spread the contamination to other parts of the facility. Contamination is a major problem for various industries, as demonstrated by various well-publicized product recalls that sometimes ruin hundreds of thousands or millions of units, yet is only discovered after the units have been placed in the stream of commerce.

Bulk materials may be obtained, transported, used, stored, or handled in relation to, as non-limiting examples, a food production facility, a pharmaceutical or nutritional product manufacturing facility, a package handling facility, a farm, a facility where bulk materials are packaged, or some other operation, any of which is referred to as a “site.” When bulk materials are obtained, transported, used, stored, or handled at a site, it is often important to know early that contaminants are absent from the bulk materials, or that additives are present in the bulk materials. In this regard, it is best to discover the condition of bulk materials prior to receipt and acceptance at the production areas of a facility, or before the bulk materials are mixed with other ingredients or run through a manufacturing process that may affect the integrity or acceptability of a final product, or that may lead to further contamination of a production line or various surfaces of a facility near the production line where contamination could produce negative consequences. In short, there is a need to determine if any substance is present in bulk materials which is potentially detrimental to the safety, edibility, integrity, nutritional or therapeutic value of the items themselves or of downstream products made from the items.

Suitable analytical methods and techniques can be any physical, chemical, or biological testing or detection method for detecting the presence of undesired contaminants (or, in other types of situation, desired additives) in bulk materials. Non-limiting examples include polymerase chain reaction testing, high performance liquid chromatography, gas chromatography-mass spectrometry, and immunoassaying. However, one cannot detect, unless one first collects, and one cannot collect without first obtaining a sample. The descriptions and teachings herein provide a more beneficial manner and point in time for sampling than prior approaches.

For example, “grab sampling” is a known approach, in which random samples are taken from bulk materials, then tested. The usefulness of grab sampling is limited, though, because contamination present in a load of bulk materials is in most cases localized. Only if grab sampling occurs in the area of localization does it have a chance to be effective. And in a grain transport vehicle, or other transport vehicles, that may carry many tons of bulk materials, a random grab sample is comparable to searching for a needle in a haystack.

Other approaches and systems collect samples related to bulk materials during the production cycle itself. Depending on the nature of the system, such approaches might be more effective than grab sampling. However, production cycle sampling and testing is not a perfect solution. For example, one may succeed in determining that a single lot of bulk materials running through a production is contaminated. After doing so, one can still discard that entire lot, or any product manufactured from that lot. Even so, there is loss, and there is potential for the spread of contamination to other parts of the production line or surrounding surfaces.

Accordingly, the earlier in a production process contaminants and additives are detected, the less impact there will be on the production system as a whole in those isolated times when an undesired contaminant is found present in the bulk materials, or when a desirable additive is found absent. From a commercial perspective, early detection allows a purchaser or recipient to reject a delivery if the load is contaminated or is found not to include a particular additive, while having a higher confidence level for accepting a delivery of bulk materials if the opposite is true. The present embodiments thus allow bulk materials to be sampled so that contaminants and additives can be detected before the load of bulk materials enters a production cycle or is exposed to production lines and surfaces. Other advantages will be evident from reviewing these descriptions and teachings.

### SUMMARY

Embodiments described herein enable samples of bulk materials to be collected from a transport vehicle, for example a transport vehicle having arrived at a facility in making its delivery. Non-limiting examples of a transport vehicle include trucks of various kinds (e.g., dump, hopper bottom, cube, flat bed), barges, railcars, totes, containers, and bags which are used to obtain, transport, store, or handle bulk materials in relation to a site, as well as any other medium which is suitable for such delivery purposes. Embodiments are also suitable to be practiced in connection with a storage tank or silo, e.g., a grain silo, in which cases the term “transport vehicle” should be interpreted broadly enough to include such structures. Accordingly, the term “transport vehicle” is meant to encompass any starting point where bulk materials are located just prior to their entering a transitioning line. At a sampling point positioned along or proximal to a transition line, a sample associated with the bulk materials is collected, and preferably testing occurs on the sample within minutes. In some embodiments, the transition line is outside the transport vehicle. Alternatively, the transition line is positioned within or substantially within the transport vehicle.

In some embodiments, the matter which is ultimately collected at a sampling point, and the sample is pulled or pushed by a fan, blower, vacuum, or other suction-generating machine or force-generating machine, which may employ positive or negative pressure, to a place for testing. Referring to a sampling point as proximal to a transitioning line is consistent with a conduit and its opening being positioned close enough to the transitioning line that suction or force urges units of bulk materials or other matter associated with the bulk materials through the opening into the conduit. If desired, continuous sampling is taken at the sampling point, meaning the suction-or force-generating machine stays on until all of the bulk materials transitions past the sampling point.

In some environments where sampling occurs, microscopic particles laden with contaminant are dispersed as fine particles or liquid droplets throughout the air surrounding the bulk materials, and these aerosolized particles are sampled. Alternatively, a sample is taken that comprises a portion of the bulk materials themselves. In operation, a conduit 15 has an opening proximal to the sampling point, which is positioned to receive under suction or other force the samples containing matter to be tested. This type of sampling is then performed at the sampling point as desired, such as on a continuous basis, or discretely as the situation calls for.

Once this occurs, the bulk materials continue along the transitioning line and then are recirculated to the transport vehicle. In some embodiments, a transitioning line is partially open, such as a conveyor belt, or substantially closed between the entry point and a return point where bulk materials exit the transitioning line. In some embodiments, the transitioning line includes a return point, which can be a chute or a drop off point, as some of the bulk materials pass upon being returned to the transport vehicle. When the sampling strategies set forth herein are combined with near-real time detection, it enables the transport vehicle to maintain its position in line, wait for results (taking minutes—not hours), and then release its load of bulk materials only when the integrity of the shipment is verified through analysis. This produces an immediate logistical benefit because, otherwise, the transport vehicle would have to wait hours before the shipment was cleared, or if it could not wait then a rejected lot would have to be picked up by another vehicle and returned to its source.

### BRIEF DESCRIPTION OF THE DRAWINGS

The drawings and descriptions herein are to be understood as illustrative of structures, features, processes, and aspects of the present embodiments and do not limit the scope of the embodiments. Accordingly, the scope of the embodiments described and/or claimed herein is not limited to the precise arrangements or scale as shown in the drawing figures.

FIG. 1A is a perspective view of a feedback system for bulk materials, which can be used with a transport vehicle, according to multiple embodiments and alternatives.

FIG. 1B is a perspective view of a feedback system for bulk materials, showing a cutaway of the transport vehicle, according to multiple embodiments and alternatives.

FIG. 2 is a diagram representing a feedback system for bulk materials, according to multiple embodiments and alternatives.

FIG. 3 is a perspective view of part of a feedback system where bulk materials and other matter move along a transitioning line past a sampling point, according to multiple embodiments and alternatives.

FIG. 4A is a flowchart describing steps related to certain aspects of a feedback system for bulk materials, according to multiple embodiments and alternatives.

FIG. 4B is a flowchart describing steps related to certain aspects of a feedback system for bulk materials, according to multiple embodiments and alternatives.

### MULTIPLE EMBODIMENTS AND ALTERNATIVES

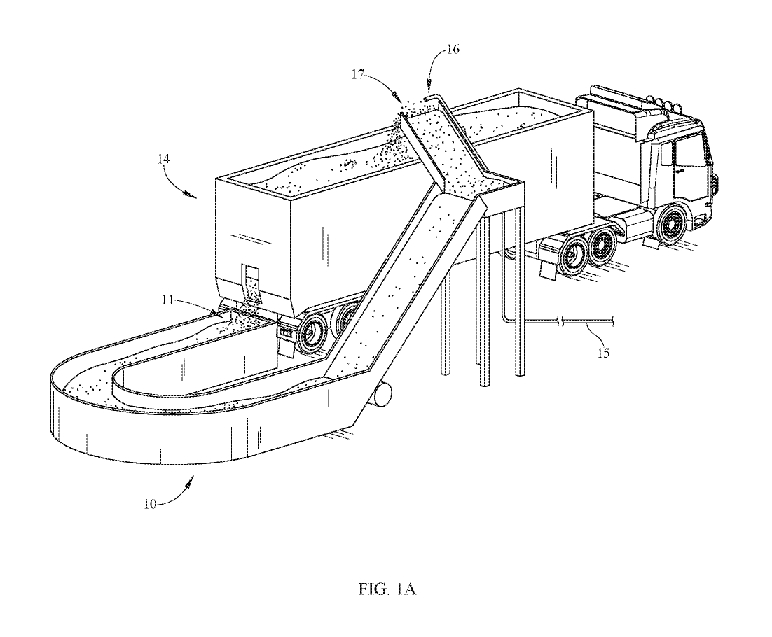

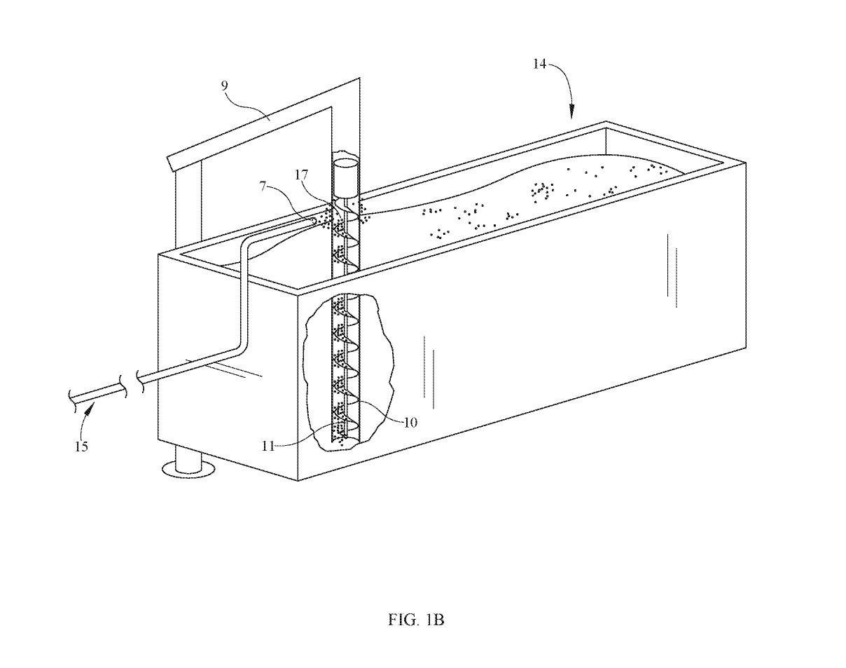

FIG. 1A offers a perspective view of a feedback system for bulk materials, suitable for use with a transport vehicle, according to multiple embodiments and alternatives. This view shows a transitioning line 10 having an entry point 11 and a return point 17, in relation to a transport vehicle 14 (not claimed) and conduit 15. Although a trailer is shown as the transport vehicle 14, present embodiments are suitable for any type of transport vehicle. Although FIG. 1A and FIG. 1B suggest grain or similar materials as the type of bulk material, it is contemplated that embodiments will be used with any bulk materials, for detecting contaminants as well as additives. In FIG. 1A, the bulk materials are transported between entry point 11 and return point 17. In the embodiment shown here, sampling point 16 is essentially at the return point 17, where bulk materials drop from the transitioning line. Though not intended as limiting, FIG. 1A is an example of a system in which much of the load of bulk materials are placed on a transitioning line, which transitions the bulk materials past a sampling point and then returns the bulk materials back into the transport vehicle. In some embodiments, at least about 50% of the bulk materials are placed on the transitioning line. As previously mentioned, the appended drawing figures are not to scale. Persons skilled in the art are capable of reasonably configuring a transitioning line to be of sufficient size, scale, and length according to purposes for which the novel system and method are used.

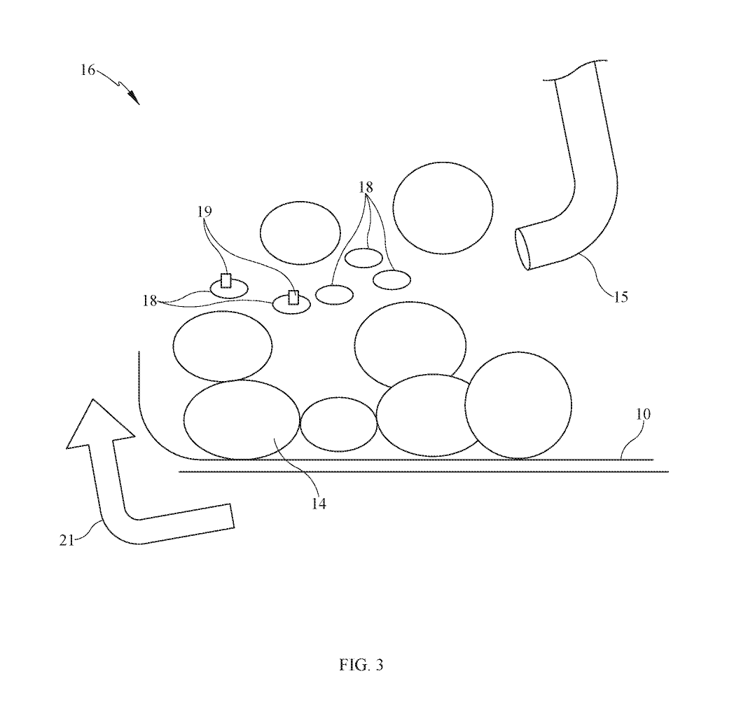

As will be appreciated, in some instances bulk materials are small units, and in FIG. 1A and FIG. 1B some of the individual bulk material units appear as small specks which are part of a larger load. Though not numbered in these figures, FIG. 3 supplies a numeral and line with reference to units of bulk materials 18. FIG. 1B offers an alternative embodiment in which transitioning line 10 is a screw-type auger that circulates the bulk materials from a first position to a second position relative to the transport vehicle. In some embodiments, this type of transitioning line 10 is positioned with use of crane 9 (not claimed) into the transport vehicle. By gaining contact with the bulk materials in the transport vehicle 14, it allows the bulk materials to enter upon and then to exit from the transitioning line 10.

FIG. 1B shows transport vehicle 14 in a non-specific way, essentially as a container where the bulk materials are. This is consistent with the fact that a transport vehicle is broadly defined, examples of which include trucks of various kinds (e.g., dump, hopper bottom, cube, flat bed), barges, railcars, totes, containers, and bags which are used to obtain, transport, store, or handle bulk materials in relation to a site, and other media suitable for delivery or storage purposes such as a storage tank or silo. In this illustration, the entry point 11 (i.e., a first position) for transitioning line 10 is near the bottom of the transport vehicle, and return point 17 (i.e., a second position) is at or slightly above the highest level or top surface of materials in the transport vehicle. Accordingly, at least some units of the bulk materials are transitioned between those two positions. Return point 17 is located proximal to the sampling point in this illustration, as the collected sample is gathered into opening 7 there. Accordingly, FIG. 1B shows units of the bulk materials moving from a first position to a second position and being dropped back into the transport vehicle. In this sense, those recirculated materials (i.e., those which are moved from a first position to a second position but which are not collected as sample) will then drop back into the transport vehicle, returning to the other bulk materials in the transport vehicle.

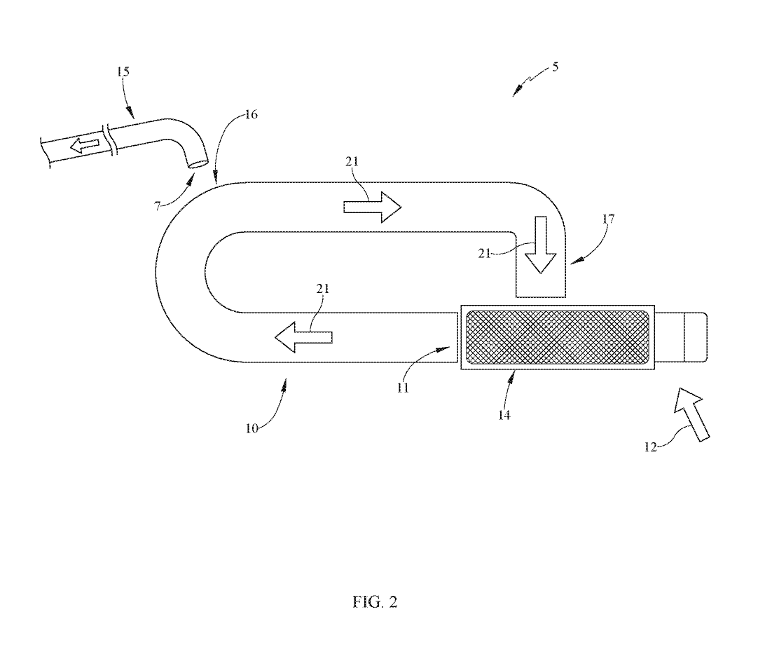

In another alternative approach as shown in FIG. 2, sampling point 16 is positioned at a location between the entry point 11 and return point 17. Except as expressly recited otherwise, the scope of any embodiments are not limited by the particular position of sampling point 16 along transitioning line 10. Accordingly, FIG. 2 is a diagram showing a feedback system 5 for timely assessment of a condition of bulk materials, representing one of multiple embodiments and alternatives. System 5 includes a transitioning line 10 for moving bulk materials from its arrival on the transitioning line to and beyond a sampling point, and then returning the bulk materials to a transport vehicle 14 from which it was first unloaded onto the transitioning line at an entry point 11. Some embodiments utilize various structures (not shown) at the entry point to facilitate the transition of bulk materials from a transport vehicle onto transitioning line 10. Non-limiting examples of such structures include gates that can be opened and closed, buckets, blowers, sweepers, pneumatic tubes, and screw conveyors, as well as shovels or other manual implements.

In some instances, the transitioning line 10 is positioned near a loading zone or other suitable space for accommodating a transport vehicle 14, close enough to have ready access to the transitioning line 10. Accordingly, the transitioning line 10 is configured to receive bulk materials from a transport vehicle 14. Bulk materials are unloaded onto the transitioning line 10, by any of a number of methods known in the art. Non-limiting examples of methods for discharging bulk materials from a transport vehicle 14 to a transitioning line 10 include letting the bulk materials drop by gravity through an opening in the transport vehicle, applying pneumatic or other suitable pumping pressure, applying vibrational force, applying suction force, applying manual force, and using a sweeper blade to transition bulk materials to the entry point 11 of transitioning line 10.

A transitioning line 10 can take a number of different forms, and the scope of present embodiments is not limited by its specific form. Non-limiting examples include a bucket unloader, a conveyor belt, an auger, a series of rollers in parallel alignment to the direction of transition, a planar low-friction surface, and any other mechanical, vibrational, magnetic, pneumatic, or other system which can be configured to effectuate the transitioning of bulk materials to move their location. If desired, a portion of a transitioning line 10 is positioned at a downward slope at some position between entry point 11 and return point 17, and configured with sidewalls to avoid loss of commodity from its boundaries. In some embodiments, the transition of bulk materials along the path of the transitioning line 10 results from being positioned on a conveyor belt, when such is used. Alternatively, the transition is actuated from transport vehicle 14 onto the transitioning line 10, and optionally along the transition line, by gravity, pneumatic or other suitable pumping pressure, vibrational force, suction force, manual force, or blade, or a combination of those.

Referring to FIG. 2, between the entry point 11 for a load of bulk materials entering the transitioning line 10 and the return point 17 exiting back to the transport vehicle 14, the materials pass a sampling point 16. Present embodiments include those where a sampling point is located anywhere along the transitioning line 10 between entry point 11 and the transport vehicle 14 while transitioning in a direction of conveyance designated by directional arrows 21. At the sampling point, a sample is gathered for testing and reporting. The sample may be collected from the bulk materials themselves, in order to test for contaminants. Optionally, system components at sampling point 16 are configured to access aerosolized particles 18 of matter (not claimed) which are in the air surrounding the bulk materials, and which will attach to contaminants 19 that may be present. It is also suitable to configure the system components to gather a sample comprising a mixture of bulk materials and aerosolized particles surrounding the bulk materials. The aerosolized particles are often found among various constituents existing in the interstitial headspace surrounding the bulk materials. In some embodiments, aerosolization of the particles is facilitated by agitating the individual units of bulk materials as they enter the vicinity of the sampling point. One approach involves blowing air over the bulk materials, or by vibrating the bulk materials as it passes the sampling point 16.

In some embodiments, the sample is collected at the point where the bulk materials drop under the force of gravity from a first level, which is positioned higher than a second level. This approach is suitable for sample collection associated with bulk materials, including bulk material sample collection, aerosolized particles sample collection, and collection of a mixture comprising bulk material units combined with aerosolized particles. In general, bulk material units are heavier and drop at a faster rate given their larger mass. By comparison, the microscopic aerosolized particles 18 are found to be on an approximate order of about 1 micrometer in diameter. Although the actual size of aerosolized particles 18 may vary across a range, these are lighter than the bulk material units, with a tendency to hover in the headspace long enough to be drawn into conduit 15.

For purpose of illustration only, a transitioning line 10 can include a bucket unloader, which is known in the field of handling grain. The commodity is transported in buckets from ground level on an upward slope to a first, higher level. There, the buckets tip over and spill their contents as a result of how the bucket unloader is configured, causing the contents of each bucket to fall to a second, lower level. In some embodiments, the site is arranged to allow transport vehicle 14 to be positioned directly below this tipping point, also referred to herein as a return point 17. Thus, the load of bulk materials enters the transitioning line 10 at entry point 11, passes sampling point 16, and returns to the transport vehicle 14 at a return point 17. The system is thus configured to provide more immediate feedback, while allowing the bulk materials to be returned to the transport vehicle while waiting for acceptance or rejection based on the ensuing near-real-time detection.

In some embodiments, conduit 15 provides a gas sample transfer (i.e., in the form of a conduit with opening 7), by virtue of its position within or proximal to the headspace of the bulk materials at a sampling point 16. In some embodiments, conduit 15 is a partially closed tube or pipe that establishes a pathway for movement of a bulk material sample or a gas sample containing aerosolized particles 18, which are transported to a particle separator and/or sample collection device. This can be done, for example, by applying a vacuum that draws the air from the interstitial headspace surrounding the bulk materials, as shown in FIG. 3, in a direction moving away from the transitioning line 10 and the sampling point 16. As seen in FIG. 3, depicting sampling point 16, the air space surrounding bulk materials 14 will contain aerosolized particulate material 18, the accessibility of which is facilitated in the manner already described, as desired. If there is contamination within bulk materials 14 passing by the sampling point, including localized contamination of bulk materials, contaminant 19 will attach to some of the aerosolized particles 18.

The gas sample (or bulk material sample in other cases) is then obtained from the sampling point and urged into and through conduit 15 away from sampling point 16 where further analysis of the sample occurs. Conduit 15 has an opening 7 at a first end proximal to the sampling point and an opening at a second end (not shown), thereby providing a pathway between such two openings. In some embodiments, conduit 15 is in fluid communication with a particle separator and/or collector where further assessment of the gas sample occurs, such that suction or another suitable source generating sufficient force transfers the sample away from the transitioning line. The sample is thus moved under force (e.g., positive pressure, negative pressure, vacuum-generated, or pneumatic force) within the conduit away from the sampling point.

Accordingly, conduit 15 provides a transport path from opening 7 proximal to sampling point 16 to a suitable testing apparatus. There are many optional separator/collectors, samplers, detectors, concentrator systems, and system components related to any of the above, as well as other analytic materials and methods as known in the field which can be configured to receive such a gas sample and further used for assessing a condition of the bulk materials. While not intended as limiting, options in this regard include an aerosol particle separation and collection apparatus, system, and method as disclosed in United States Patent Application, “Aerosol Particle Separation and Collection,” filed Dec. 29, 2014, and published on Jul. 2, 2015 as U.S. Pub. No. 20150183003, the entire teachings and disclosures of which are incorporated by reference as if fully set forth here.

In general, after coming in close proximity to opening 7 and passing sampling point 16, matter that is not collected as sample continues transitioning along the direction of conveyance, and exit the transitioning line 10 at a return point 17. There, the bulk materials are returned to a transport vehicle 14. Optionally, this is the same transport vehicle from which the bulk materials accessed the transitioning line. Alternatively, this is a separate transport vehicle than the one from which bulk materials were received. Optionally, return point 17 is configured as a drop zone, a chute, a drop tube, a cyclone, a gate with a spring-loaded hinged door or other controls allowing bulk materials to pass only when there is a sufficient mass present at the return point, or only when assurance is provided that a transport vehicle is positioned in zone 12.

A transport vehicle 14 can then, if desired, move away from zone 12, and wait for results of analysis of the gas sample. The systems and methods disclosed herein, when combined with detection techniques offering near-real-time detection, allow the transport vehicle, with its bulk materials returned to it, to wait minimal time to learn the results of analysis. With conventional practices, this could take hours to perform, leaving the operators with two undesirable choices: allowing the bulk materials to be brought into the facility as processing begins, or having a transport vehicle wait for those hours before knowing the commodity was being accepted at the facility, or whether the commodity was being rejected and would have to be returned to its source.

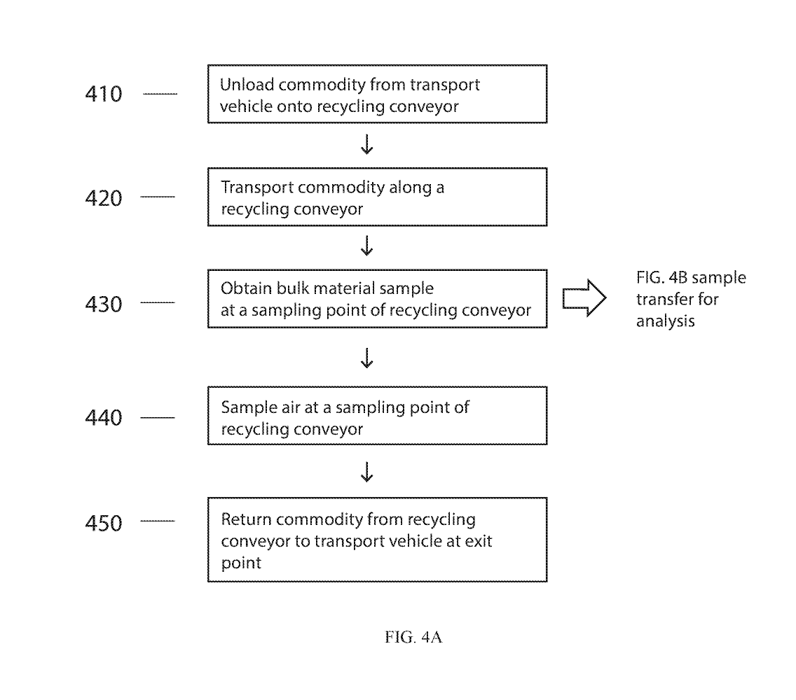

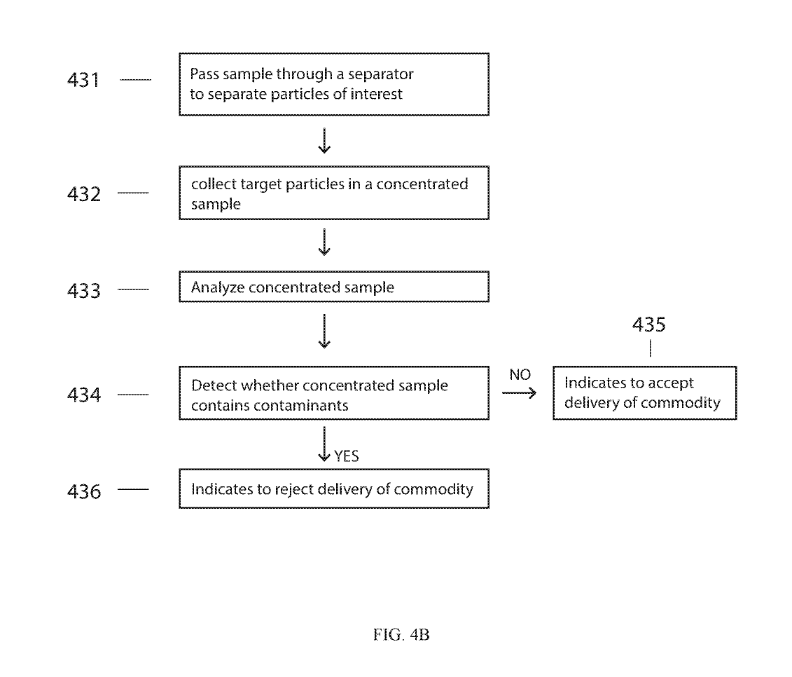

Referring now to FIG. 4A, at step 410 a transitioning line 10 is provided to receive bulk materials that are unloaded from a transport vehicle. At step 420, the load of bulk materials is then allowed to pass a sampling point 16 along the transitioning line 10. The extent of area considered to be a sampling point depends upon the type of bulk materials, the type and size of the transitioning line 10, and the type of conduit 15 which is employed. In some embodiments, the sampling point is configured to allow for 70% to 90% of aerosolized particles in the such area to be pulled into or otherwise enter conduit 15 and be transferred to the collector/separator, but certain heavier units making up the bulk materials do not enter. As desired, step 430 entails continuous sampling at the sampling point. Beyond the sampling point 16, the load of bulk materials is allowed to continue transitioning along the course of transitioning line 10, at step 440, to return point 17 where it is returned to transport vehicle 14 at step 450. In some embodiments sample point 16 and return point 17 are the same, or at least are positioned in close proximity.

Turning now to FIG. 4B, the gas sample passing through conduit 15 is used for assessing a condition of the bulk materials that have moved along the transitioning line 10. Accordingly, the gas sample is transported at step 431 to a separator where target particles, including contamination-laden particles or particles bearing additives, are separated from particles of no interest or lesser interest, or otherwise to collect such target particles in concentrated form in a collection medium, at step 432. The concentrated form is referred to for these purposes as the “concentrated sample” to distinguish it from the gas sample from which it was produced. The concentrated sample can then be analyzed at step 433.

In turn, step 434 represents the go/no-go determination based on the results of analysis. If the concentrated sample does not contain contaminants (or does contain the desired additives), at step 435, this provides an indication to accept delivery of the commodity. However, if the concentrated sample does contain contaminants (or does not contain the desired additives), at step 436, this provides an indication to reject delivery of the commodity.

The system and methods disclosed herein thus provide sample collection that facilitates sample analysis, with the option of near-real time detection for contamination before bulk materials actually progress to the production line. Also provided is a quicker and more efficient way to determine whether such goods shipped as bulk materials satisfy commercial standards of merchantability, or fitness for their intended purpose, and whether they should be accepted or rejected.

Each of the various structures described herein according to multiple embodiments and alternatives is formed from a range of materials, as may be selected by a user and which will be readily apparent to those of skill in the art to which the present disclosure applies. Materials may be selected, for example, according to durability, weight, and inertness with aerosolized particles within a sample.

It is to be understood that the embodiments described and/or claimed herein are not limited in their application to the details of the teachings and descriptions set forth herein, or as illustrated in the following examples. Rather, it will be understood that the embodiments are capable of being practiced or carried out in multiple ways, according to many alternatives based on these descriptions and teachings.

Further, it will be understood that the phraseology and terminology used herein is for the purpose of description and should not be regarded as limiting. The use herein of “including,” “comprising,” “e.g.,” “such as, for example,” “containing,” or “having” and variations of those words is meant in a non-limiting way to encompass the items listed thereafter, and equivalents of those, as well as additional items. Accordingly, the foregoing descriptions are meant to illustrate a number of embodiments and alternatives, rather than limiting to the precise forms and processes disclosed herein. The descriptions herein are not intended to be exhaustive. It will be understood by those having ordinary skill in the art that modifications and variations of these embodiments are reasonably possible in light of the above teachings and descriptions.

What is claimed is:

1. A feedback system for bulk materials, comprising:
a transitioning line having an entry point arranged to receive bulk materials from a transport vehicle and transition the bulk materials along a path proximal to a sampling point; and
a conduit having an opening positioned proximal to the sampling point; and
a return point configured to return bulk materials to a transport vehicle.

2. The feedback system of claim 1, wherein the conduit is configured to transfer a sample obtained from bulk materials away from the sampling point.

3. The feedback system of claim 1, wherein a portion of the transitioning line is positioned at a downward slope at a position between the entry point and the return point.

4. The feedback system of claim 1, wherein bulk materials are returned to the transport vehicle from which bulk materials were received.

5. The feedback system of claim 1, wherein bulk materials are returned to a separate transport vehicle than the transport vehicle from which bulk materials were received.

6. The feedback system of claim 1, wherein the transitioning line receives at least about 50% of the bulk materials from the transport vehicle.

7. A method of assessing the condition of bulk materials, comprising:
configuring a transition line to receive bulk materials from a transport vehicle;
transitioning the bulk materials along the transitioning line to a sampling point;
collecting a sample associated with the bulk materials;
transferring the sample away from the transitioning line; and
returning at least some of the transitioned bulk materials to a transport vehicle.

8. The feedback system of claim 7, wherein bulk materials are returned to the transport vehicle from which bulk materials were received.

9. The method of claim 7, wherein bulk materials are returned to a separate transport vehicle than the transport vehicle from which bulk materials were received.

10. The method of claim 7, wherein the sample is transferred by one or more of gravity, pneumatic pumping pressure, vibrational force, suction force, manual force, blade, or a combination of those.

11. The method of claim 7, wherein the transitioning line receives at least about 50% of the bulk materials from the transport vehicle.
